(19) United States
(12) Patent Application Publication
(10) Pub. No.: US 2009/0250431 A1
(43) Pub. Date: Oct. 8, 2009

(54) SUBSTRATE PROCESSING APPARATUS AND SUBSTRATE PROCESSING METHOD

(76) Inventors: Minako INUKAI, Kawasaki-Shi (JP); Yoshihiro OGAWA, Yokkaichi-Shi (JP); Hiroshi TOMITA, Yokohama-Shi (JP); Hiroyasu IIMORI, Yokohama-Shi (JP); Yuji YAMADA, Yokohama-Shi (JP); Yoshihiro UOZUMI, Hopewell Junction, NY (US); Linan JI, Yokohama-Shi (JP); Kaori UMEZAWA, Kamakura-Shi (JP); Hisadhi OKUCHI, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/404,681

(22) Filed: Mar. 16, 2009

(30) Foreign Application Priority Data
Mar. 19, 2008 (JP) 2008-71638

(51) Int. Cl. C23F 1/00; B08B 3/08; C23F 1/08; B08B 13/00

(52) U.S. Cl. 216/51; 216/41; 134/28; 134/29; 156/345.11; 134/95.1

(57) ABSTRACT

A substrate processing method that processes a substrate on which a plurality of patterns adjacent to each other are formed, has: supplying a first processing liquid to a principal surface of the substrate that is dry and has the patterns formed thereon to make the first processing liquid adhere to the principal surface of the substrate; and supplying a second processing liquid having a higher surface tension than the first processing liquid to the principal surface of the substrate in the state where the first processing liquid adheres to the principal surface of the substrate to process the principal surface of the substrate with the second processing liquid.

### CROSS-REFERENCE TO RELATED APPLICATION

This application is based upon and claims the benefit of priority from the prior Japanese Patent Application No. 2008-71638, filed on Mar. 19, 2008, the entire contents of which are incorporated herein by reference.

### BACKGROUND OF THE INVENTION

1. Field of the Invention

The present invention relates to a substrate processing apparatus that processes a substrate, such as a semiconductor substrate and a glass substrate, with a processing liquid, such as a chemical and pure water, and a substrate processing method therefor.

2. Background Art

A conventional substrate processing apparatus cleans a patterned substrate with a chemical (processing liquid) in a processing tank, supplies a low surface tension solution having a lower surface tension than the chemical to the processing tank to replace the chemical, then removes the substrate from the processing tank, and dries the substrate (see Japanese Patent Laid-Open No. 2007-214447, for example).

This apparatus can prevent the pattern from collapsing because of the surface tension of the chemical when the substrate is removed from the processing tank.

However, as described above, the conventional technique is not intended to prevent collapse of the pattern when the substrate is put into the chemical.

### SUMMARY OF THE INVENTION

According to one aspect of the present invention, there is provided: a substrate processing method, comprising:

supplying a first processing liquid to a principal surface of the substrate, the substrate is dry and has a plurality of patterns adjacent to each other on the principal surface, and getting the principal surface of the substrate wet by the first processing liquid; and
supplying a second processing liquid having a higher surface tension than the first processing liquid to the principal surface of the substrate in the state of wetting in the first processing liquid, and processing the principal surface of the substrate with the second processing liquid.

According to the other aspect of the present invention, there is provided: a substrate processing apparatus, comprising:

a pre-processing liquid supplying part to supply a first processing liquid to a principal surface of the substrate, the substrate has a plurality of patterns adjacent to each other on the principal surface; and

a processing part to supply a second processing liquid having a higher surface tension than the first processing liquid to the principal surface of the substrate in the state of wetting in the first processing liquid, and processing the principal surface of the substrate with the second processing liquid.

### BRIEF DESCRIPTION OF THE DRAWINGS

FIG. 1 is a diagram for illustrating amorphous silicon patterns formed on a semiconductor substrate before and after collapse due to resist stripping;

FIG. 2 is a diagram showing a model for illustrating an example of collapse of adjacent patterns because of the surface tension of a liquid (processing liquid) having high surface tension;

FIG. 3A is a diagram showing models for illustrating other examples of collapse of a plurality of adjacent patterns because of the surface tension of a liquid (processing liquid) having high surface tension;

FIG. 3B is a diagram showing models for illustrating other examples of collapse of a plurality of adjacent patterns because of the surface tension of a liquid (processing liquid) having high surface tension;

FIG. 4 is a diagram showing a model for illustrating a case where patterns are wet with a liquid having low surface tension;

FIG. 5 is a diagram showing an exemplary configuration of a substrate processing apparatus 100 according to the first embodiment;

FIG. 6 is a diagram for illustrating an exemplary flow of a substrate processing method according to the first embodiment;

FIG. 7 is a diagram for illustrating an exemplary flow of the substrate processing method according to the first embodiment in the case where the first processing liquid is isopropyl alcohol and the second processing liquid is pure water;

FIG. 8 is a diagram for illustrating another exemplary flow of the substrate processing method according to the first embodiment in the case where the first processing liquid is isopropyl alcohol and the second processing liquid is pure water;

FIG. 9 is a circuit diagram showing a configuration of a substrate processing apparatus 200 according to the second embodiment of the present invention;

FIG. 10 is a diagram for illustrating an exemplary flow of the substrate processing method according to the second embodiment in the case where the first processing liquid is isopropyl alcohol and the second processing liquid is pure water;

FIG. 11 is a diagram for illustrating an exemplary flow of a substrate processing method according to the third embodiment;

FIG. 12A is a cross-sectional view of a substrate in a step in the substrate processing method according to the fourth embodiment;

FIG. 12B is a cross-sectional view of a substrate in a step in the substrate processing method according to the fourth embodiment, is continuous from FIG. 12A;

FIG. 13A is a cross-sectional view of a substrate in a step in a substrate processing method according to the fifth embodiment;

FIG. 13B is a cross-sectional view of a substrate in a step in the substrate processing method according to the fifth embodiment, is continuous from FIG. 13A; and

FIG. 13C is a cross-sectional view of a substrate in a step in the substrate processing method according to the fifth embodiment, is continuous from FIG. 13B.

### DETAILED DESCRIPTION

### Comparison Example

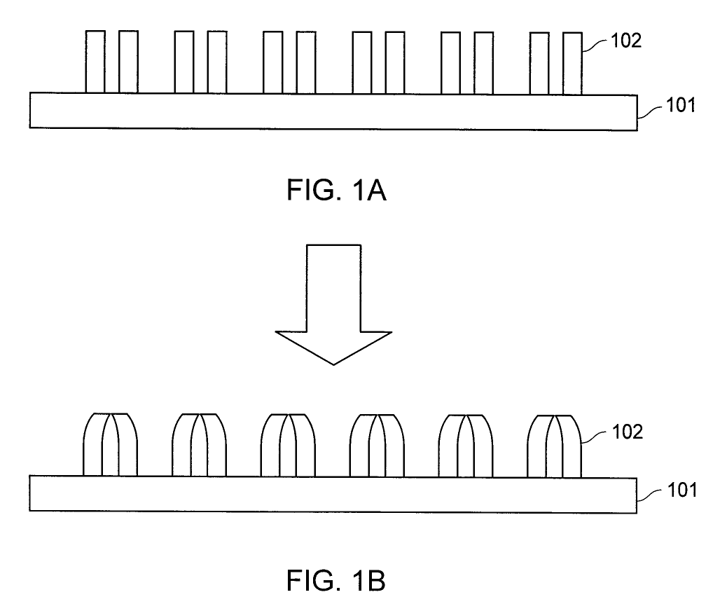

FIG. 1 is a diagram for illustrating amorphous silicon patterns formed on a semiconductor substrate before and after collapse due to resist stripping.

In recent years, miniaturization of patterns formed on substrates, such as semiconductor substrates and glass substrates, have advanced. The conventional measures, which are performed before drying the substrate 101 subjected to a processing using a chemical (processing liquid), such as resist stripping, cleaning and etching, cannot prevent such miniaturized patterns 102 from collapsing because of the surface tension of the chemical when the dry substrate 101 gets wet with the chemical in the processing as shown in FIG. 1.

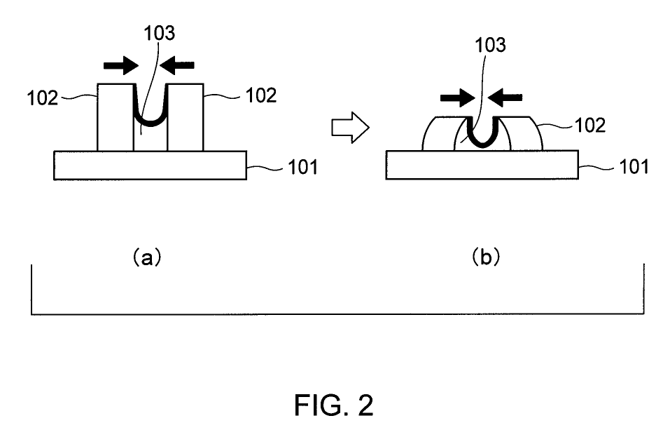

FIG. 2 shows a model for illustrating an example of collapse of adjacent patterns because of the surface tension of a liquid (processing liquid) having high surface tension.

As shown in FIG. 2, in the case where the processing liquid 103 has high surface tension, if the processing liquid 103 penetrates into gaps between adjacent patterns 102 on the substrate 101 when the dry substrate 101 gets wet with the processing liquid 103, the surface tension of the processing liquid 103 is applied to the adjacent patterns 102 (see FIG. 2(a)). The surface tension may cause collapse of a plurality of adjacent patterns 102 (see FIG. 2(b)).

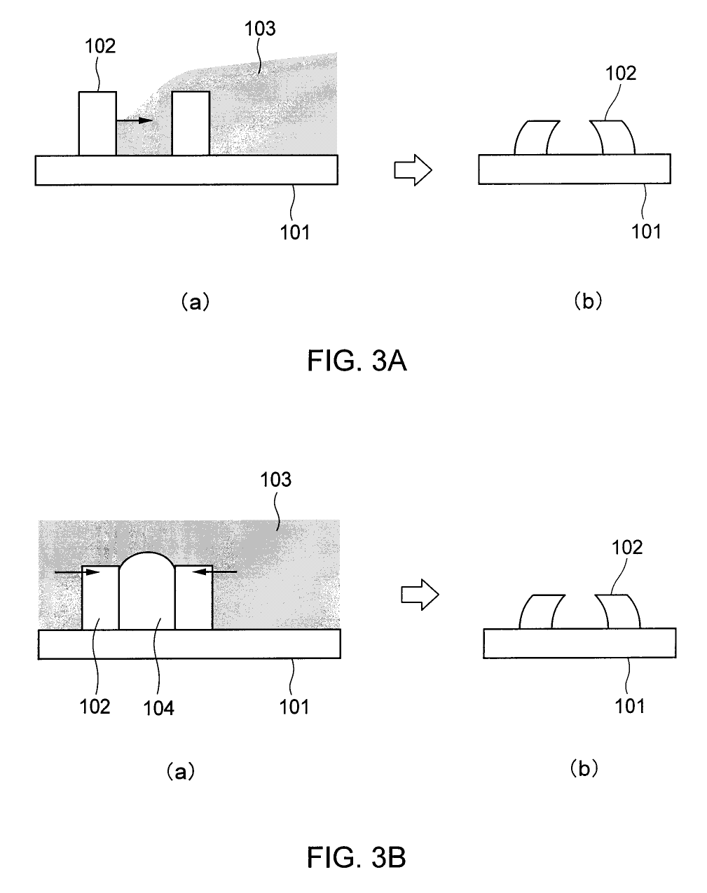

FIGS. 3A and 3B show models for illustrating other examples of collapse of a plurality of adjacent patterns because of the surface tension of a liquid (processing liquid) having high surface tension.

As shown in FIG. 3A, in the case where the processing liquid 103 has high surface tension, at a point where a pattern 102, gas and the processing liquid 103 coexists, the pattern 102 is subjected to a stress caused by the surface tension of the processing liquid 103 when the dry substrate 101 gets wet with the processing liquid 103. The stress may cause collapse of a plurality of adjacent patterns 102.

Furthermore, as shown in FIG. 3B, in the case where the processing liquid 103 has high surface tension, the processing liquid 103 may not penetrate into a groove between adjacent patterns 102 formed on the substrate 101 when the dry substrate 101 gets wet with the processing liquid 103. In this case, an air bubble develops between the adjacent patterns 102 and applies a stress to the patterns 102. The stress may cause collapse of a plurality of adjacent patterns 102.

If the patterns collapse before processing the substrate with the processing liquid, a desired processing cannot be carried out to achieve desired characteristics. For example, if patterns serving as a mask collapses before a processing with a processing liquid (before immersion in the processing liquid), etching cannot be accomplished in a desired way.

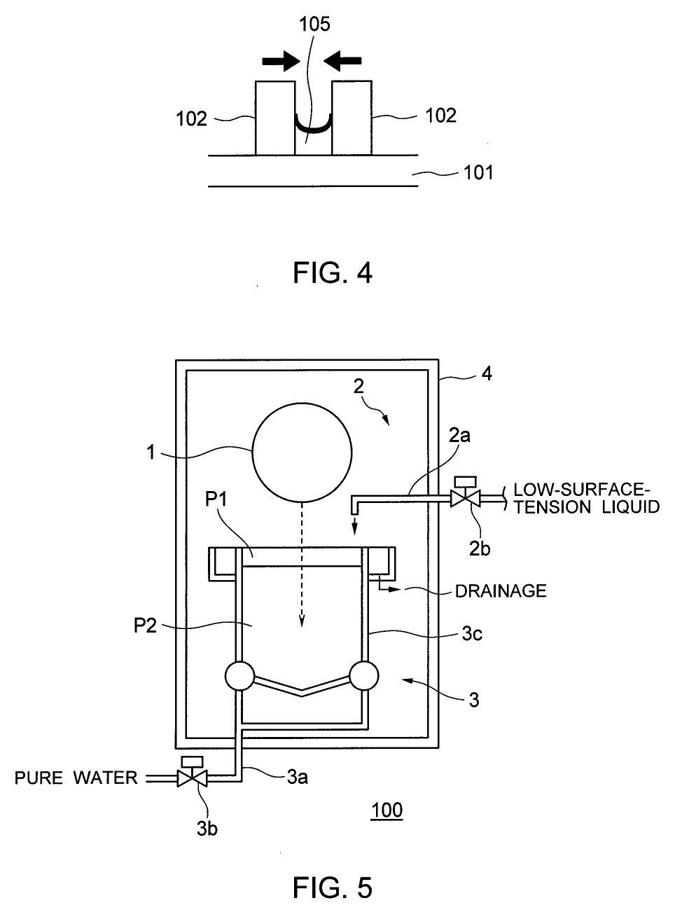

FIG. 4 shows a model for illustrating a case where patterns are wet with a liquid having low surface tension.

As shown in FIG. 4, in the case where the patterns 102 are wet with a liquid 105 having low surface tension, the surface tension applied to the patterns 102 is low. In addition, in the case where the patterns 102 get wet with a liquid 105 having low surface tension, such air bubble as shown in FIG. 3 is unlikely to occur. That is, in this case, the patterns 102 are unlikely to collapse.

Thus, according to an aspect of the present invention, a processing for reducing the surface tension that is applied to patterns when a substrate is first exposed to a processing liquid (chemical) is performed. The processing with the chemical is started after the entire substrate is wet with a liquid.

In this way, the patterns are prevented from collapsing due to the force produced by the mechanisms described above when the dry substrate gets wet with the processing liquid.

In the following, embodiments of the present invention will be described with reference to the drawings.

### First Embodiment

In a first embodiment of the present invention, which is an aspect of the present invention, a batch-type processing of a substrate will be described.

FIG. 5 is a diagram showing an exemplary configuration of a substrate processing apparatus 100 according to the first embodiment, which is an aspect of the present invention.

As shown in FIG. 5, the substrate processing apparatus 100 has a pre-processing liquid supplying part 2, a processing part 3, and a chamber 4. The substrate processing apparatus 100 uses the pre-processing liquid supplying part 2 and the processing part 3 to process a principal surface of a wafer 1, which is a substrate on which a plurality of patterns adjacent to each other are formed. The term “principal surface” of the wafer (substrate) 1 means a surface including the upper surface of the wafer and the upper and side surfaces of the pattern (the same holds true for the following description).

The wafer 1 may be a semiconductor substrate or a glass substrate, for example. The pattern formed on the wafer 1 may be an oxide film, a nitride film or a resist film, for example.

The pre-processing liquid supplying part 2 has a first processing liquid supplying pipe 2a and a first valve 2b.

A first processing liquid P1 is supplied to the chamber 4 through the first processing liquid supplying pipe 2a by operating the first valve 2b on the first processing liquid supplying pipe 2a.

The processing part 3 has a second processing liquid supplying pipe 3a, a second valve 3b and a processing tank 3c.

The second processing liquid supplying pipe 3a is connected to the processing tank 3c. A second processing liquid P2 is supplied to the processing tank 3c through the second processing liquid supplying pipe 3a by operating the second valve 3b on the second processing liquid supplying pipe 3a.

The processing tank 3c is installed in the sealed chamber 4. The processing tank 3c stores the second processing liquid P2. Processing of the wafer 1 is performed by immersing the wafer 1 in the second processing liquid P2 in the processing tank 3c.

The first processing liquid P1 has a lower surface tension than the second processing liquid P2 (in other words, the second processing liquid P2 has a higher surface tension than the first processing liquid P1). More preferably, the first processing liquid P1 has a higher wettability to the principal surface of the wafer 1 than the second processing liquid P2.

For example, in the case where the second processing liquid P2 is pure water, the first processing liquid P1 may be an alcohol, such as isopropyl alcohol and hydrofluoroether, or a solution containing a surface active agent.

The processing tank 3c is configured to receive the first processing liquid P1 through the first processing liquid supplying pipe 2a. As a result, the processing tank 3c stores the first processing liquid P1 in the upper part thereof and the second processing liquid P2 in the lower part thereof. In the processing tank 3c, the wafer 1 is processed with the second processing liquid P2 after the first processing liquid P1 in the upper part is discharged by overflow.

“The process with the second processing liquid” may be etching of a part of the principal surface of the wafer (upper surface of the wafer) using the pattern formed on the wafer as a mask, removal of particles or metallic impurities by an alkali or acid, or resist stripping, for example.

Although not shown, another processing liquid supplying pipe is connected to the processing tank 3c. Thus, another processing liquid can be supplied to the processing tank 3c through this processing liquid supplying pipe by operating a valve (not shown) on the processing liquid supplying pipe. That is, the processing part 3 is configured so that other processing liquid than the second processing liquid P2 can be supplied to the principal surface of the wafer 1 in the processing tank 3c.

Next, a substrate processing method using the substrate processing apparatus 100 configured as described above will be described.

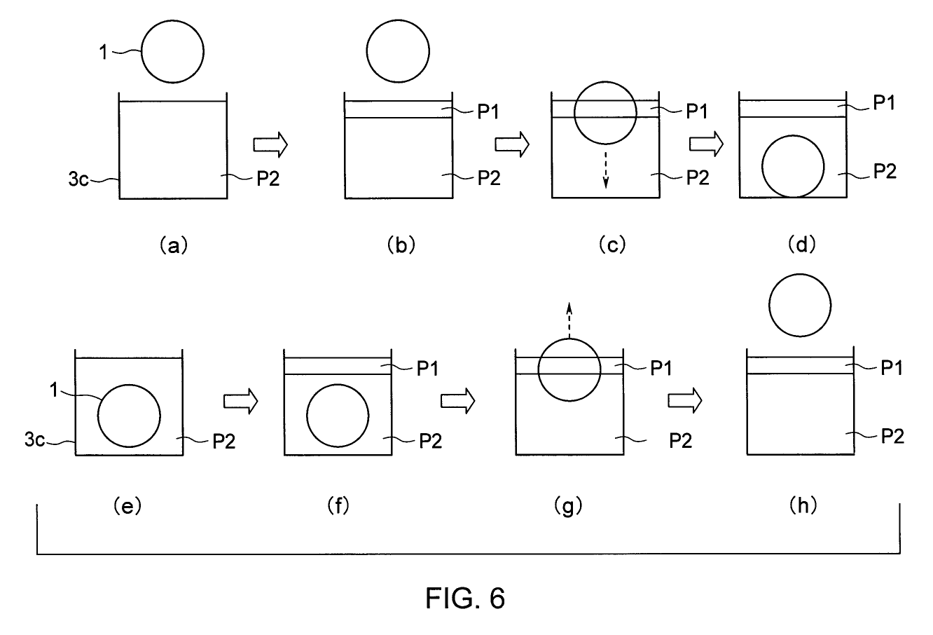

FIG. 6 is a diagram for illustrating an exemplary flow of a substrate processing method according to the first embodiment.

As shown in FIG. 6, first, the second processing liquid P2 is supplied to the processing tank 3c through the second processing liquid supplying pipe 3a to store the second processing liquid P2 in the processing tank 3c (a).

Then, the first processing liquid P1 is supplied to the processing tank 3c through the first processing liquid supplying pipe 2a to store the first processing liquid P1 in the upper part of the processing tank 3c. At this time, the second processing liquid P2 is stored in the lower part of the processing tank 3c (b).

Then, the dry wafer 1 is put into the processing tank 3c from above. That is, the dry wafer 1 passes through the layer of the liquid (first processing liquid P1) having a lower surface tension than the second processing liquid P2 before the wafer 1 is put into the second processing liquid P2 (c).

That is, the first processing liquid P1 is supplied to at least the principal surface of the dry wafer 1 to make the first processing liquid P1 adhere to the principal surface of the wafer 1. In this way, the principal surface of the wafer gets wet with the liquid having a low surface tension.

Then, the wafer 1 is immersed into the second processing liquid P2 stored in the lower part of the processing tank 3c (d). That is, in the state where the first processing liquid P1 adheres to the principal surface of the wafer 1, the second processing liquid P2 is supplied to the principal surface of the wafer 1 (to replace the first processing liquid P1 with the second processing liquid P2). In this way, the force produced by the mechanisms described above can be suppressed to prevent collapse of the pattern.

Then, the first processing liquid P1 is discharged form the processing tank 3c by overflow, and then, the principal surface of the wafer is processed with the second processing liquid P2 (e).

Through the flow described above, the wafer can be processed with the second processing liquid P2 while preventing collapse of the pattern before the processing with the second processing liquid P2.

After the processing with the second processing liquid P2 is completed, the first processing liquid P1 is supplied to the processing tank 3c through the first processing liquid supplying pipe 2a again to store the first processing liquid P1 in the upper part of the processing tank 3c (f).

Then, before the wafer is removed into the atmosphere, the wafer is passed through the layer of the liquid (first processing liquid P1) having a lower surface tension than the second processing liquid P2 (g).

Then, the wafer is removed into the atmosphere and let dry (h). Since the first processing liquid P1 has a lower surface tension than the second processing liquid as described above, the force produced by the mechanisms described above can be suppressed to prevent collapse of the pattern.

Through the flow described above, the wafer can be processed with the second processing liquid P2 while preventing collapse of the pattern formed on the wafer.

Next, the flow from (a) to (d) in FIG. 6 will be described by referring to a more specific example.

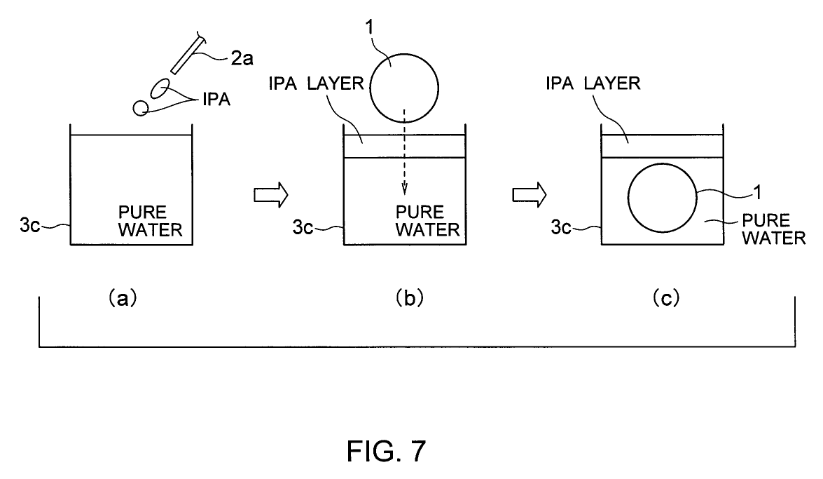

FIG. 7 is a diagram for illustrating an exemplary flow of the substrate processing method according to the first embodiment in the case where the first processing liquid is isopropyl alcohol and the second processing liquid is pure water.

As shown in FIG. 7, IPA, which is the first processing liquid, is directly added onto pure water, which is the second processing liquid P2, in the processing tank 3c to form an IPA layer (a).

The wafer put into the processing tank 3c passes through the IPA layer (b) and then is immersed in the pure water (c). The following flow is the same as the flow from (e) shown in FIG. 6.

In the example described above, the upper layer of the first processing liquid P1 is formed before the wafer is put into the processing tank 3c. However, the first processing liquid P1 may be first stored in the processing tank 3c, and then the second processing liquid P2 may be supplied to the processing tank 3c to make the first processing liquid P1 overflow.

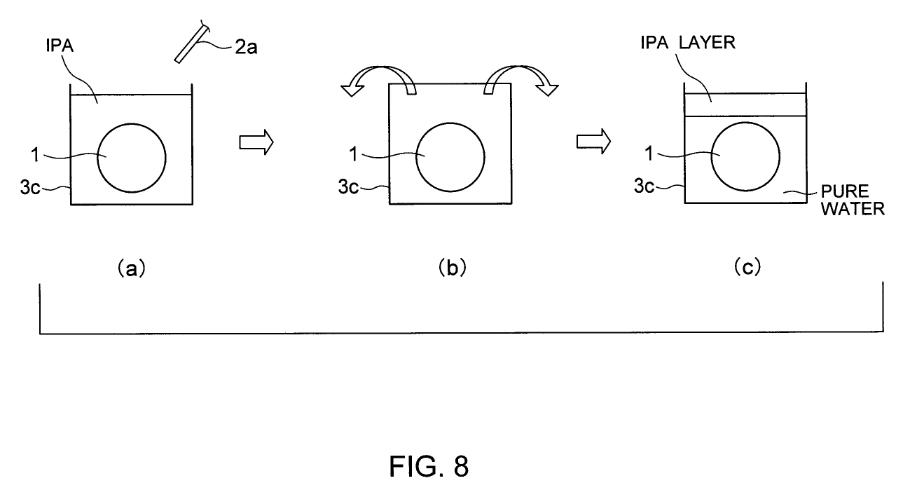

FIG. 8 is a diagram for illustrating another exemplary flow of the substrate processing method according to the first embodiment in the case where the first processing liquid is isopropyl alcohol and the second processing liquid is pure water.

As shown in FIG. 8, when the wafer is put into the processing tank 3c, the processing tank 3c is already filled with IPA (a). Thus, the principal surface of the wafer gets wet with the liquid having low surface tension. In other words, IPA is supplied to the principal surface of the wafer to make IPA adhere to the principal surface of the wafer.

Then, pure water is supplied to the processing tank 3c to make the IPA overflow (b) and eventually expel the IPA (c). That is, in the state where the IPA adheres to the principal surface of the wafer 1, pure water is supplied to the principal surface of the wafer 1. Thus, the force produced by the mechanisms described above can be suppressed to prevent collapse of the pattern.

As described above, the substrate processing apparatus and the substrate processing method according to this embodiment can prevent collapse of the pattern formed on the substrate before the processing with the processing liquid.

### Second Embodiment

In the first embodiment, an example in which the wafer is put into the processing tank that already stores the first processing liquid has been described.

In a second embodiment, an example in which a wafer is put into a processing tank that stores a second processing liquid from an atmosphere of a first processing liquid will be described.

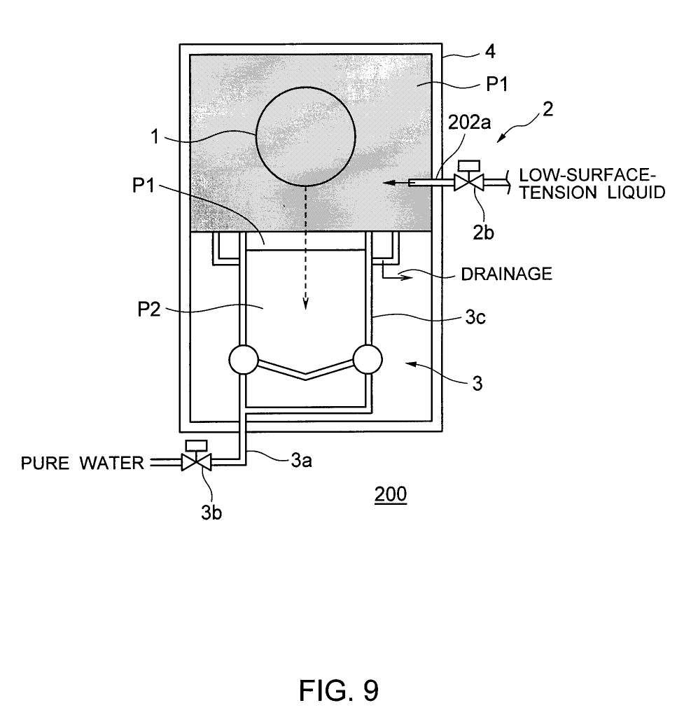

FIG. 9 is a circuit diagram showing a configuration of a substrate processing apparatus 200 according to the second embodiment of the present invention, which is an aspect of the present invention. In FIG. 9, the same reference numerals as those in FIG. 5 denote the same components as those in the first embodiment.

Referring to FIG. 9, as with the substrate processing apparatus 100 according to the first embodiment, the substrate processing apparatus 200 has a pre-processing liquid supplying part 2, a processing part 3 and a chamber 4. The substrate processing apparatus 200 uses the pre-processing liquid supplying part 2 and the processing part 3 to process a wafer 1, which is a substrate having a plurality of patterns adjacent to each other formed on the principal surface thereof.

The pre-processing liquid supplying part 2 has a first processing liquid supplying pipe 202a and a first valve 2b.

A first processing liquid P1 is supplied to the chamber 4 through the first processing liquid supplying pipe 202a by operating the first valve 2b on the first processing liquid supplying pipe 202a.

As described above, in the first embodiment, the first processing liquid P1 is directly supplied to the processing tank 3c through the first processing liquid supplying pipe 2a. However, in the second embodiment, vapor of the first processing liquid P1 is supplied to the chamber 4 through the first processing liquid supplying pipe 202a. The first processing liquid P1 is stored in the upper part of the processing tank 3c by cooling the vapor of the first processing liquid P1.

The remainder of the configuration of the substrate processing apparatus 200 is the same as that of the substrate processing apparatus 100 according to the first embodiment.

Next, a substrate processing method using the substrate processing apparatus 200 configured as described above will be described.

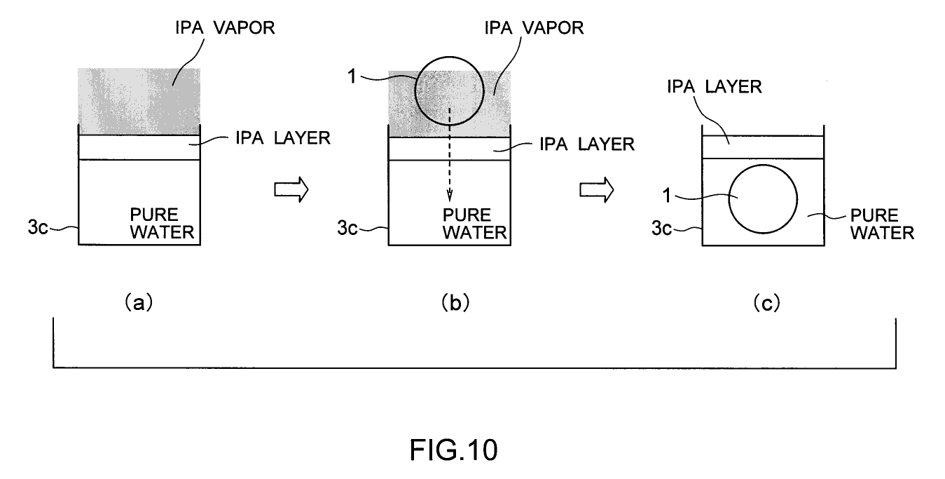

FIG. 10 is a diagram for illustrating an exemplary flow of the substrate processing method according to the second embodiment in the case where the first processing liquid is isopropyl alcohol and the second processing liquid is pure water.

As shown in FIG. 10, vapor of IPA, which is the first processing liquid P1, is supplied to the chamber 4, thereby forming an IPA layer on the pure water, which is the second processing liquid P2, in the processing tank 3c (a).

The dry wafer 1 put into the processing tank 3c passes through the IPA vapor and the IPA layer (b) and then is immersed in the pure water (c). That is, IPA, which is the first processing liquid P1, is made to adhere to the principal surface of the dry wafer 1, and then, pure water, which is the second processing liquid P2, is supplied to the principal surface of the wafer 1 (to replace the IPA with the pure water). In this way, the force produced by the mechanisms described above can be suppressed to prevent collapse of the pattern.

The following flow is the same as the flow in the first embodiment, for example.

If the first processing liquid adheres to the principal surface of the substrate only by putting the wafer into the vapor of the first processing liquid P1, the first processing liquid P1 does not always need to be stored in the upper part of the processing tank 3c. However, the processing tank 3c preferably stores the first processing liquid P1 in the upper part thereof.

As described above, the substrate processing apparatus and the substrate processing method according to this embodiment can prevent collapse of the pattern formed on the substrate before the processing with the processing liquid.

### Third Embodiment

In the first and second embodiments, batch-type processings of a substrate have been described.

In a third embodiment, a single-wafer type processing of a substrate will be described. In this embodiment described below, a first processing liquid P1 is isopropyl alcohol, and a second processing liquid P2 is pure water. However, other processing liquids described above can be used in various combinations.

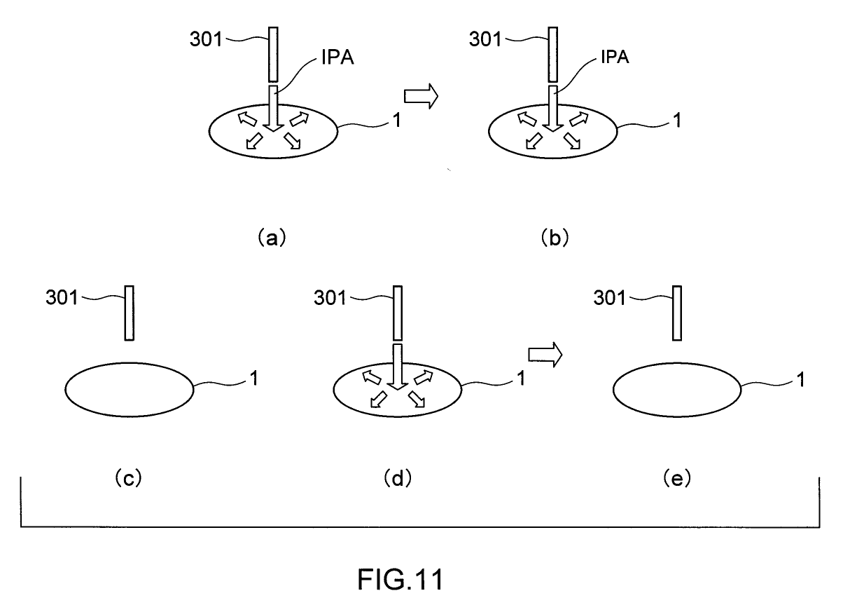

FIG. 11 is a diagram for illustrating an exemplary flow of a substrate processing method according to the third embodiment.

As shown in FIG. 11, first, IPA, which is the first processing liquid P1, is supplied at least to the principal surface of a dry wafer 1 from a nozzle 301 (a). That is, IPA is supplied to the principal surface of the dry wafer 1 to make the IPA adhere to the principal surface of the wafer. In this way, the principal surface of the wafer 1 gets wet with the liquid having low surface tension.

Then, pure water, which is the second processing liquid P2, is supplied to the principal surface of the wafer 1 from the nozzle 301 (b). That is, in the state where the IPA adheres to the principal surface of the wafer 1, pure water is supplied to the principal surface of the wafer 1 (to replace the IPA with the pure water). In this way, the force produced by the mechanisms described above can be suppressed to prevent collapse of the pattern.

Then, the principal surface of the wafer is processed (cleaned) with pure water (c).

Through the flow described above, the wafer can be processed with pure water while preventing collapse of the pattern before the processing with the pure water.

After the processing is completed, in the state where the pure water adheres to the principal surface of the wafer 1, IPA is supplied to the principal surface of the wafer 1 from the nozzle 301 again (to replace the pure water with the IPA). In this way, the principal surface of the wafer 1 gets wet with the liquid having low surface tension (d).

Then, the wafer 1 is let dry (e). Since IPA has a lower surface tension than pure water as described above, the force produced by the mechanisms described above can be suppressed to prevent collapse of the pattern.

Through the flow described above, the wafer can be processed with pure water, which is the second processing liquid P2, while preventing collapse of the pattern formed on the wafer.

As described above, the substrate processing method according to this embodiment can prevent collapse of the pattern formed on the substrate before the processing with the processing liquid.

### Fourth Embodiment

In a fourth embodiment, an example in which a microstructural pattern and a resist pattern that can collapse because of a surface tension are formed on a substrate will be described. A substrate processing method according to the fourth embodiment can be applied to the embodiments 1 to 3 described above, for example.

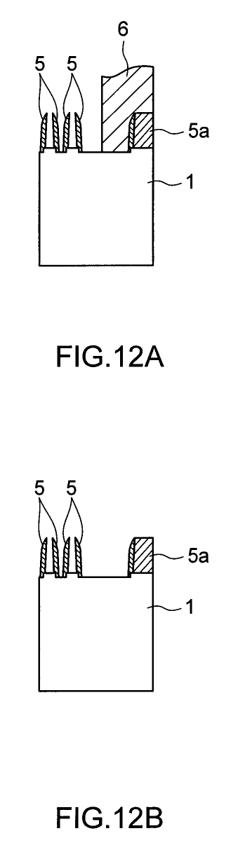

FIGS. 12A and 12B are cross-sectional views of a substrate in steps in the substrate processing method according to the fourth embodiment.

As shown in FIG. 12A, an amorphous silicon pattern 5 is formed on a substrate 1 by dry etching. In addition, a TEOS film 5a formed on the substrate 1 is covered with a resist pattern 6.

First, a first processing liquid P1 is supplied to the principal surface of the dry substrate (wafer) 1 in the state shown in FIG. 12A to make the first processing liquid P1 adhere to the principal surface of the wafer. For example, in the case where the substrate processing method is applied to the embodiment 1 or 2, the pre-processing liquid supplying part 2 shown in FIG. 5 or 9 supplies the first processing liquid P1 to the principal surface of the dry substrate (wafer) 1 to make the first processing liquid P1 adhere to the principal surface of the wafer.

In this way, the principal surface of the substrate 1 gets wet with the liquid having low surface tension.

The first processing liquid P1 preferably has a higher wettability than the second processing liquid P2 and does not dissolve the resist. In addition, the first processing liquid P1 is preferably removed from the pattern in the second processing liquid P2 or reacts with the second processing liquid P2 to be decomposed so that the first processing liquid P1 does not spoil the effect of the second processing liquid P2.

Then, in the state where the first processing liquid P1 adheres to the principal surface of the substrate 1, the second processing liquid P2 is supplied to the principal surface of the wafer 1 (to replace the first processing liquid P1 with the second processing liquid P2). For example, in the case where the substrate processing method is applied to the embodiment 1 or 2, the processing part 3 shown in FIG. 5 or 9 supplies the second processing liquid P2 to the principal surface of the wafer 1 in the state where the first processing liquid P1 adheres to the principal surface of the substrate 1.

Thus, the force produced by the mechanisms described above can be suppressed to prevent collapse of the amorphous silicon pattern 5.

Then, the principal surface of the substrate 1 is processed (cleaned) with the second processing liquid P2. For example, in the case where the substrate processing method is applied to the embodiment 1 or 2, the processing part 3 shown in FIG. 5 or 9 processes the principal surface of the substrate 1 with the second processing liquid P2.

Through the flow described above, the substrate 1 can be processed with the second processing liquid P2 while preventing collapse of the amorphous silicon pattern 5 before the processing with the second processing liquid P2.

Then, after the principal surface of the substrate 1 is processed with the second processing liquid P2, in the state where the second processing liquid P2 adheres to the principal surface of the substrate 1, a third processing liquid P3 having a lower surface tension than the second processing liquid P2 is supplied to the principal surface of the substrate 1. For example, in the case where the substrate processing method is applied to the embodiment 1 or 2, in the state where the second processing liquid P2 adheres to the principal surface of the substrate 1 after the principal surface of the substrate 1 is processed with the second processing liquid P2, the processing part 3 shown in FIG. 5 or 9 supplies the third processing liquid P3 having a lower surface tension than the second processing liquid P2 to the principal surface of the substrate 1.

The third processing liquid P3 preferably dissolves the resist. If the third processing liquid P3 dissolves the resist, the resist pattern 6 is dissolved in the third processing liquid P3 and removed from the substrate 1 as shown in FIG. 12B.

In the case where the second processing liquid P2 is buffered hydrogen fluoride (BHF), the third processing liquid P3 is IPA, for example.

Then, in the state where the third processing liquid P3 adheres to the principal surface of the substrate 1, the principal surface of the substrate is dried (by evaporation). Since the third processing liquid P3 has a lower surface tension than the second processing liquid P2 as described above, the force produced by the mechanisms described above can be suppressed to prevent collapse of the pattern.

Through the flow described above, the substrate 1 can be processed with the second processing liquid P2 while preventing collapse of the pattern formed on the substrate 1.

In particular, if the third processing liquid P3 is used to dissolve the resist, the cleaning step (cleaning with sulfuric acid and hydrogen peroxide) in the conventional process performed to remove the resist can be omitted, for example. Thus, the risk of collapse of the pattern in the conventional cleaning process can be avoided.

As described above, the substrate processing method according to this embodiment can prevent collapse of the pattern formed on the substrate before the processing with the processing liquid.

### Fifth Embodiment

In a fifth embodiment, another example in which a microstructural pattern and a resist pattern that can collapse because of a surface tension are formed on a substrate will be described. In the following, in particular, a case where a resist pattern is used as a mask to etch an underlying minute pattern will be described. A substrate processing method according to the fifth embodiment can be applied to the embodiments 1 to 3 described above, for example.

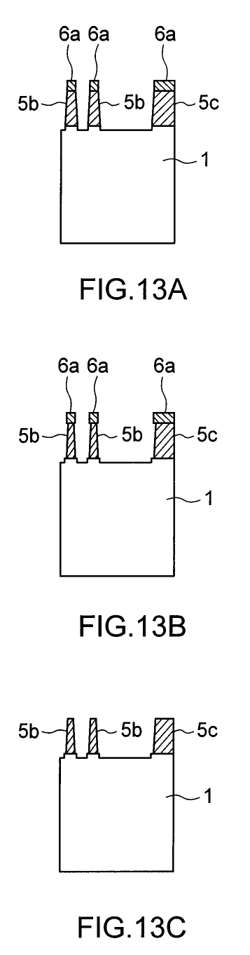

FIGS. 13A to 13C are cross-sectional views of a substrate in steps in a substrate processing method according to the fifth embodiment.

As shown in FIG. 13A, oxide film patterns 5b and 5c are formed on a substrate 1. In addition, a resist pattern 6a is formed on the oxide patterns 5b and 5c.

First, a first processing liquid P1 is supplied to the principal surface of the dry substrate (wafer) 1 in the state shown in FIG. 13A to make the first processing liquid P1 adhere to the principal surface of the wafer. For example, in the case where the substrate processing method is applied to the embodiment 1 or 2, the pre-processing liquid supplying part 2 shown in FIG. 5 or 9 supplies the first processing liquid P1 to the principal surface of the dry substrate (wafer) 1 to make the first processing liquid P1 adhere to the principal surface of the wafer.

In this way, the principal surface of the substrate 1 gets wet with the liquid having low surface tension.

The first processing liquid P1 preferably has a higher wettability than the second processing liquid P2 and does not dissolve the resist. In addition, the first processing liquid P1 is preferably removed from the pattern in the second processing liquid P2 or reacts with the second processing liquid P2 to be decomposed so that the first processing liquid P1 does not spoil the effect of the second processing liquid P2.

Then, in the state where the first processing liquid P1 adheres to the principal surface of the substrate 1, the second processing liquid P2 is supplied to the principal surface of the wafer 1 (to replace the first processing liquid P1 with the second processing liquid P2). For example, in the case where the substrate processing method is applied to the embodiment 1 or 2, the processing part 3 shown in FIG. 5 or 9 supplies the second processing liquid P2 to the principal surface of the wafer 1 in the state where the first processing liquid P1 adheres to the principal surface of the substrate 1.

Thus, the force produced by the mechanisms described above can be suppressed to prevent collapse of the minute oxide film pattern 5b.

Then, the principal surface of the substrate 1 is processed (etched) with the second processing liquid P2. For example, in the case where the substrate processing method is applied to the embodiment 1 or 2, the processing part 3 shown in FIG. 5 or 9 processes the principal surface of the substrate 1 with the second processing liquid P2. In this embodiment, side surfaces of the oxide film patterns 5b and 5c are etched (FIG. 13B).

Through the flow described above, the substrate 1 can be processed with the second processing liquid P2 while preventing collapse of the oxide film pattern 5b before the processing with the second processing liquid P2.

Then, after the principal surface of the substrate 1 is processed with the second processing liquid P2, in the state where the second processing liquid P2 adheres to the principal surface of the substrate 1, a third processing liquid P3 having a lower surface tension than the second processing liquid P2 is supplied to the principal surface of the substrate 1. For example, in the case where the substrate processing method is applied to the embodiment 1 or 2, in the state where the second processing liquid P2 adheres to the principal surface of the substrate 1 after the principal surface of the substrate 1 is processed with the second processing liquid P2, the processing part 3 shown in FIG. 5 or 9 supplies the third processing liquid P3 having a lower surface tension than the second processing liquid P2 to the principal surface of the substrate 1.

The third processing liquid P3 preferably dissolves the resist. If the third processing liquid P3 dissolves the resist, the resist pattern 6 is dissolved in the third processing liquid P3 and removed from the substrate 1 as shown in FIG. 13C.

Furthermore, in the case where the second processing liquid P2 is buffered hydrogen fluoride (BHF), for example, the third processing liquid P3 is IPA or the like.

Then, in the state where the third processing liquid P3 adheres to the principal surface of the substrate 1, the principal surface of the substrate is dried (by evaporation). Since the third processing liquid P3 has a lower surface tension than the second processing liquid P2 as described above, the force produced by the mechanisms described above can be suppressed to prevent collapse of the pattern.

Through the flow described above, the substrate 1 can be processed with the second processing liquid P2 while preventing collapse of the pattern formed on the substrate 1.

In particular, the memory cell part of an NAND flash memory includes a pattern containing minute lines and spaces. In general, a peripheral circuit has a pattern that is wider than or differs in film composition from the pattern of the memory cell part. In such a case, the pattern of the peripheral circuit has to be covered with a resist pattern before cleaning or etching the memory cell part. The methods according to the embodiments 4 and 5 described above can be applied to such a case.

What is claimed is:

1. A substrate processing method, comprising:
supplying a first processing liquid to a principal surface of the substrate, the substrate is dry and has a plurality of patterns adjacent to each other on the principal surface, and getting the principal surface of the substrate wet by the first processing liquid; and
supplying a second processing liquid having a higher surface tension than the first processing liquid to the principal surface of the substrate in the state of wetting in the first processing liquid, and processing the principal surface of the substrate with the second processing liquid.

2. The method according to claim 1, wherein the first processing liquid has a higher wettability to the principal surface of the substrate than the second processing liquid.

3. The method according to claim 1, wherein the processing with the second processing liquid is etching of the principal surface of the substrate using the patterns as a mask.

4. The method according to claim 1, wherein the processing with the second processing liquid is removal of an impurity on the substrate using an alkali or acid.

5. The method according to claim 1, wherein the patterns are resist films.

6. The method according to claim 5, wherein the processing with the second processing liquid is stripping of the resist films.

7. The method according to claim 1, wherein the first processing liquid is isopropyl alcohol (IPA).

8. The method according to claim 1, wherein the first processing liquid is hydrofluoroether (HFE).

9. The method according to claim 1, wherein the first processing liquid is a solution containing a surface active agent.

10. The method according to claim 1, wherein the patterns include oxide films or nitride films.

11. The method according to claim 1, further comprising:
after the processing with the second processing liquid, supplying a third processing liquid having a lower surface tension than the second processing liquid to the principal surface of the substrate in the state of wetting in the second processing liquid; and
drying the principal surface of the substrate in the state of wetting in the third processing liquid.

12. The method according to claim 11, wherein the first processing liquid does not dissolve the resist, and the third processing liquid dissolves the resist.

13. A substrate processing apparatus, comprising:
a pre-processing liquid supplying part to supply a first processing liquid to a principal surface of the substrate, the substrate has a plurality of patterns adjacent to each other on the principal surface; and
a processing part to supply a second processing liquid having a higher surface tension than the first processing liquid to the principal surface of the substrate in the state of wetting in the first processing liquid, and processing the principal surface of the substrate with the second processing liquid.

14. The apparatus according to claim 13, wherein the first processing liquid has a higher wettability to the principal surface of the substrate than the second processing liquid.

15. The apparatus according to claim 13, wherein the processing with the second processing liquid is etching of the principal surface of the substrate using the patterns as a mask.

16. The apparatus according to claim 13, wherein the processing with the second processing liquid is removal of an impurity on the substrate using an alkali or acid.

17. The apparatus according to claim 13, wherein a processing with the second processing liquid is stripping of the resist films.

18. The apparatus according to claim 13, wherein the processing part supplies a third processing liquid having a lower surface tension than the second processing liquid to the principal surface of the substrate in the state of wetting in the second processing liquid after the processing with the second processing liquid.

19. The apparatus according to claim 18, wherein the first processing liquid does not dissolve the resist, and the third processing liquid dissolves the resist.
